(19) United States
(12) Patent Application Publication
(10) Pub. No.: US 2026/0368863 A1
(43) Pub. Date: Nov. 19, 2026

(54) PERFORMING FACE IMAGE RESTORATION TASKS USING DENOISING NEURAL NETWORKS

(71) Applicant: Google LLC, Mountain View, CA (US)

(72) Inventors: Hossein Talebi, San Jose, CA (US); Peyman Milanfar, Menlo Park, CA (US); Mauricio Delbracio, Sunnyvale, CA (US); Kangfu Mei, Mountain View, CA (US); Viraj Jayminkumar Shah, Mountain View, CA (US); Mo Zhou, Baltimore, MD (US); Keren Ye, Mountain View, CA (US)

(21) Appl. No.: 19/679,524

(22) Filed: May 15, 2026

Related U.S. Application Data
(60) Provisional application No. 63/807,436, filed on May 16, 2025.

(51) Int. Cl. G06T 5/60; G06T 5/50; G06T 5/70

(52) U.S. Cl. CPC G06T 5/60; G06T 5/50; G06T 5/70; G06T 2207/20081; G06T 2207/20084; G06T 2207/20212; G06T 2207/30201

(57) ABSTRACT

Systems and methods for performing image restoration of a degraded image of a face of an agent. More specifically, the image restoration task is performed by conditioning a denoising neural network on one or more reference images of the face of the agent in addition to the degraded image.

### CROSS-REFERENCE TO RELATED APPLICATION

This application claims priority to U.S. Provisional Application No. 63/807,436, filed on May 16, 2025. The disclosure of the prior application is considered part of and is incorporated by reference in the disclosure of this application.

### BACKGROUND

This specification relates to processing images using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

### SUMMARY

This specification describes a system implemented as computer programs on one or more computers in one or more locations that performs image restoration tasks (also referred to as image restoration “procedures”) using a denoising neural network.

The subject matter described in this specification can be implemented in particular embodiments so as to realize one or more of the following advantages.

Recently, image restoration has seen significant improvements along with the rise of diffusion models, particularly in terms of generated image quality. However, existing restoration methods, including the face-specific ones, still suffer from unsatisfactory identity preservation when processing facial imagery. This limitation can substantially degrade the user experience, given the human perceptual acuity for subtle variations in facial features. In some real-world applications, such as digital albums, when restoring a low-quality face image, it is possible to leverage other high-quality face images from the same person as references to better preserve the identity and appearance. Consequently, reference-based face restoration methods have been proposed. Nevertheless, the existing methods do not fully exploit the potential of reference faces. Thus, existing reference-based restoration approaches suffer from suboptimal performance in both identity preservation and image quality.

This specification describes various techniques to more effectively utilize the reference face images and further enhance the performance of reference-based face restoration.

For example, this specification describes how to generate a comprehensive representation for the reference face. This “composite” representation includes multiple embeddings that are generated as output from multiple different embedding neural networks that focus on different information in the reference face from high-level to low-level. For example, the comprehensive representation can include identity embeddings as high-level identity information and a general face representation that includes both high-level semantic information and low-level face information. These comprehensive and multi-level representations can exploit the reference face images better than previous work that only uses a single type of representation, thereby capturing only partial information which is insufficient for accurate restoration. For example, the face embedding only contains identity information, while other potentially useful details like the visual appearance of the reference face are not encoded in face embedding at all, preventing the denoising neural network from leveraging these properties of the reference image. Thus, by incorporating embeddings from multiple different embedding neural networks, the system causes the denoising neural network to generate images that more accurately incorporate context from the reference image.

As another example, this specification describes an objective for use during training that incorporates similarity between an estimate of the restored image and the reference image. By incorporating this similarity, this objective mitigates learning inefficiencies. In particular, the ground-truth faces in the training examples used for training may not be difficult enough for the denoising neural network to reconstruct, which makes the existing similarity loss magnitude very small after a short period of training. By incorporating a more difficult sample, namely the reference face, into the loss, the learning inefficiency problem can be effectively addressed, leading to a significant performance improvement.

Moreover, while the denoising neural network can be trained using the described techniques with only a single reference image per ground truth restored image, at inference time, the input to the denoising neural network can be extended to support multiple reference face images through a method based on classifier-free guidance at the inference stage, which requires no extra training.

The details of one or more embodiments of the subject matter of this specification are set forth in the accompanying drawings and the description below.

Other features, aspects, and advantages of the subject matter will become apparent from the description, the drawings, and the claims.

### BRIEF DESCRIPTION OF THE DRAWINGS

FIG. 1 is a block diagram of an example image restoration system.

FIG. 2 is a flow diagram of an example process for generating a restored image.

FIG. 3 is a flow diagram of an example process for performing a denoising step.

FIG. 4 is a flow diagram of an example process for training the denoising neural network.

FIG. 5 shows an example of the operation of the system during training.

Like reference numbers and designations in the various drawings indicate like elements.

### DETAILED DESCRIPTION

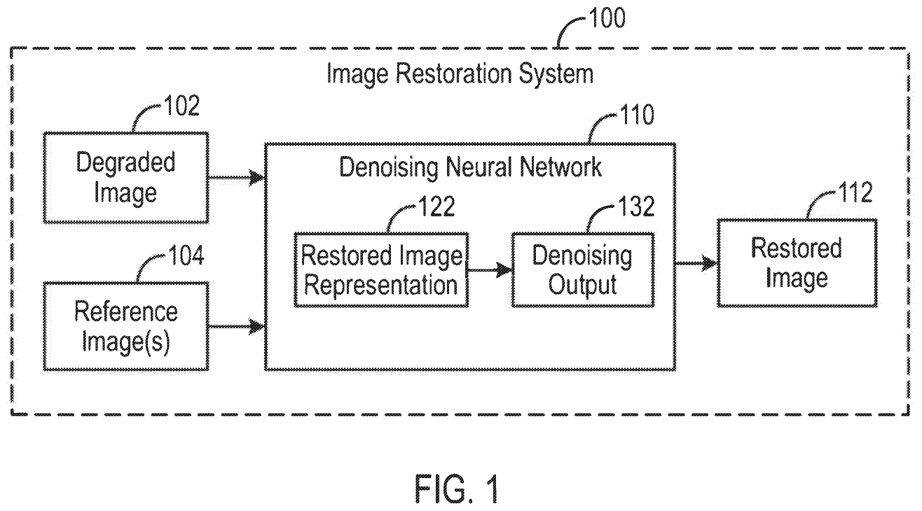

FIG. 1 shows an example image restoration system 100. The image restoration system 100 is an example of a system implemented as computer programs on one or more computers in one or more locations in which the systems, components, and techniques described below are implemented.

The system 100 performs image restoration tasks (also referred to as image restoration “procedures”) using a denoising neural network 110.

Generally, performing “image restoration” refers to recovering details, e.g., pixel-level details, from a degraded image 102 while preserving the original semantic information in the degraded image 102. In other words, image restoration tasks remove degradation from a degraded image 102 to generate a restored image 112. Examples of degradation that the system 100 can remove from an input image 102 include removing noise from the intensity values of the pixels in the degraded image 102, deblurring the degraded image 102, i.e., to remove blurring from the image, removing compression or other artifacts from the degraded image 102, and so on.

More specifically, the system 100 performs restoration tasks that require restoring an image of the face of an agent, e.g., of a person, a digital avatar, an animal, and so on, conditioned on one or more reference images 104 of the face of the agent.

That is, the system performs restoration on the input degraded image 102 in a manner that preserves the face identity of the face of the agent in the degraded image 102. In particular, the system 100 performs this restoration by making use of one or more reference images 104 that also depict the face of the agent and are generally not degraded (or, more generally, are not as degraded as the input degraded image 102).

The system 100 performs this restoration using a denoising neural network 110.

Generally, at each of multiple denoising steps, the denoising neural network 110 processes one or more inputs that each include a representation 122 of the restored image 102 to generate a respective denoising output 132 for each input.

Generally, the denoising output 132 defines an estimate of the noise component of the representation 122, i.e., of the noise that has been added to a ground truth representation of the ground truth restored image to generate the representation 122.

For example, the denoising output 122 can be a prediction of the noise component. As another example, the denoising output 122 can be an estimate of the ground truth representation.

The system 100 then updates the representation 122 of the restored image using a final denoising output generated from the one or more denoising outputs 132. For example, at each iteration other than the last, the system 100 can generate an estimate of the representation using the final denoising output and then apply a diffusion sampler to the estimate. For the last iteration, the estimate can be the updated representation or the system 100 can use the sampler.

After the last denoising step, the system 100 generates the restored image 112 from the final representation 122 of the restored image 112.

In any of the above examples, the representations of images received as input by the denoising neural network 110 and updated using the denoising neural network 100 can either be representations in the output space, i.e., so that the values in the representation are values of image pixels, or representations a latent space, i.e., so that the values in the representation are values in a latent representation of an image in the output space.

When the representations are in a latent space, the system 100 can generate the restored image 112 in output space by processing the final representation 122 in the latent space using a decoder neural network, e.g., one that has been pre-trained in an auto-encoder framework with an encoder neural network. During training of the denoising neural network 110, the system 100 or another training system can use an encoder neural network, e.g., one that has been pre-trained jointly with the decoder in the auto-encoder framework, to encode target images in the output space to generate target representations for the denoising neural network in the latent space.

The denoising neural network 110 can be any appropriate denoising neural network that is configured to receive an input that includes a current (noisy) representation of an image and a conditioning input and to generate a denoising output.

As described above, in some implementations, the denoising neural network performs a denoising process in output space, e.g., pixel space. In this example, the data items (“representations”) operated on and generated by the denoising neural network have values for each pixel that specify color values, e.g., RGB values or another color encoding scheme.

Examples of such denoising neural networks include Imagen.

In some other implementations, the denoising neural network 110 performs a denoising process in latent space, e.g., in a latent space that is lower-dimensional than the output space. That is, the data items (“representations”) operated on by the denoising neural network are latent representations and the values in the representations are learned, latent values, e.g., rather than color values.

Examples of such denoising neural networks include mobile diffusion.

More specifically, this specification describes how the system 100 can more effectively perform this task by (i) representing each reference image 104 using a composite embedded representation that captures different characteristics of the face of the agent, (ii) having trained the denoising neural network 110 on an improved loss function that has an identity loss term that does not plateau quickly during training, or (iii) both.

The restored images generated by the system 100 can be used for a variety of purposes. For example, the functionality of the system 100 can be implemented as part of a digital photo album application or a photos application. In these applications, the system 100 can restore low-quality face images, e.g., automatically in response to detecting a low-quality face image or in response to user requests, by leveraging other high-quality face images of the same person available in the album as references. This process ensures better preservation of the person's identity and visual appearance. As another example, the functionality of the system 100 can be implemented as part of a photo database application or a photo archive application. In these applications, the system 100 can be used to automatically restore and tag faces in old, low-quality photos, making them clearer for automated photo sorting or personal device access. In either of these examples, the system 100 can be implemented on the user device on which the application is accessed, or remotely. Alternatively, the system 100 can be implemented in a hybrid manner, where the front-end component (e.g., a mobile app) handles initial data processing (receiving the degraded image and reference images) and the back-end component (the cloud server) performs the heavy computation of image restoration.

Further to the descriptions above, a user may be provided with controls allowing the user to make an election as to both if and when systems, programs, or features described herein may enable collection of user information (e.g., images associated with the user as described above), and if the user is sent content or communications from a server. In addition, certain data may be treated in one or more ways before it is stored or used, so that personally identifiable information is removed. For example, a user's identity may be treated so that no personally identifiable information can be determined for the user. Thus, the user may have control over what information is collected about the user, how that information is used, and what information is provided to the user.

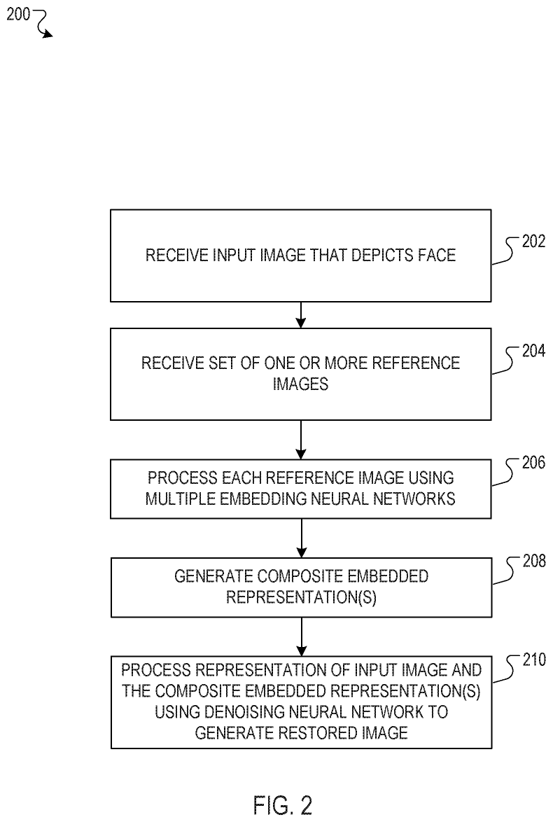

FIG. 2 is a flow diagram of an example process 200 for performing image restoration on a degraded image. For convenience, the process 200 will be described as being performed by a system of one or more computers located in one or more locations. For example, an image restoration system, e.g., the image restoration system 100 of FIG. 1, appropriately programmed in accordance with this specification, can perform the process 200.

The system receives an input image that depicts a face of an agent (step 202). As indicated above, the input image is generally degraded in one or more aspects.

The system receives a set of one or more reference images that each depict the face of the agent (step 204). That is, each reference image is an image of the face of the same agent as depicted in the degraded input image.

For each reference image, the system processes the reference image using each of multiple different embedding neural networks (step 206).

Each of the embedding neural networks generates a respective set of one or more embeddings of the reference image. Generally, each of the sets of embeddings capture different properties of the face of the agent from each other set of embeddings. That is, the embedding neural networks have been configured, trained, or both so that the set of embeddings generated by the embedding neural network capture different properties of the face of the agent than those generated by the other embedding neural network(s).

For example, the embedding neural networks can include an embedding neural network that has been trained to generate an embedding that represents the identity of the face of the agent. One example of such a model is the ArcFace model, a face recognition model that enforces an angular margin loss in its embedding space to generate embeddings representing person identity. For example, this model can have a convolutional architecture, e.g., the ResNet50 architecture.

As another example, the embedding neural networks can include another embedding neural network that has been trained to generate an embedding that represents high-level semantic and low-level information of the face of the agent. Examples of high-level features include face attributes. Similarly, examples of low-level information include visual appearance features. One example of such a model is one trained using the FaRL (General Facial Representation Learning in a Visual-Linguistic Manner) framework, in which an embedding neural network learns a general facial representation by exploring both high-level semantic meaning using a contrastive loss on image-text pairs, and low-level information using masked image modeling. For example, this model can be a convolutional neural network or a Vision Transformer neural network.

For each reference image, the system generates a composite embedded representation of the reference image from the respective sets of one or more embeddings generated by the different embedding neural networks (step 208).

For example, the system can generate the composite embedded representation by projecting each embedding in the respective sets of one or more embeddings to a shared projection space to generate a set of projected embeddings and then concatenate the projected embeddings, i.e., so that the concatenation is a concatenation of the projected embeddings for the embedding neural networks. In particular, for each embedding neural network, the system can use a respective learned projection layer to project the embedding(s) generated by the neural network to the shared embedding space. The learned projection layers for the embedding neural networks can be trained jointly with the denoising neural network, e.g., using the training process described below.

Optionally, the system can apply a positional encoding to the concatenated projected embeddings to generate the composite embedded representation. For example, the system can add a respective positional encoding, e.g., a sinusoidal positional encoding or another appropriate encoding that uniquely identifies each position in the concatenated projected embedding sequence, to each projected embedding to generate the composite embedded representation.

The system processes a representation of the input image and the respective composite embedded representations of each of the one or more reference images in the set of one or more reference images using a denoising neural network to generate a restored image that restores the input image (step 210).

In general, the system initializes a representation of the restored image, e.g., by sampling the values in the representation from a noise distribution, e.g., a Gaussian distribution or another appropriate distribution. The system then updates the representation of the restored image at each of one or more denoising steps using the denoising neural network and conditioned on the representation of the input image and the respective composite embedded representations. Generally, each denoising step removes noise from the representation of the restored image, i.e., results in a less noisy representation that incorporates context from the input image and the reference image(s).

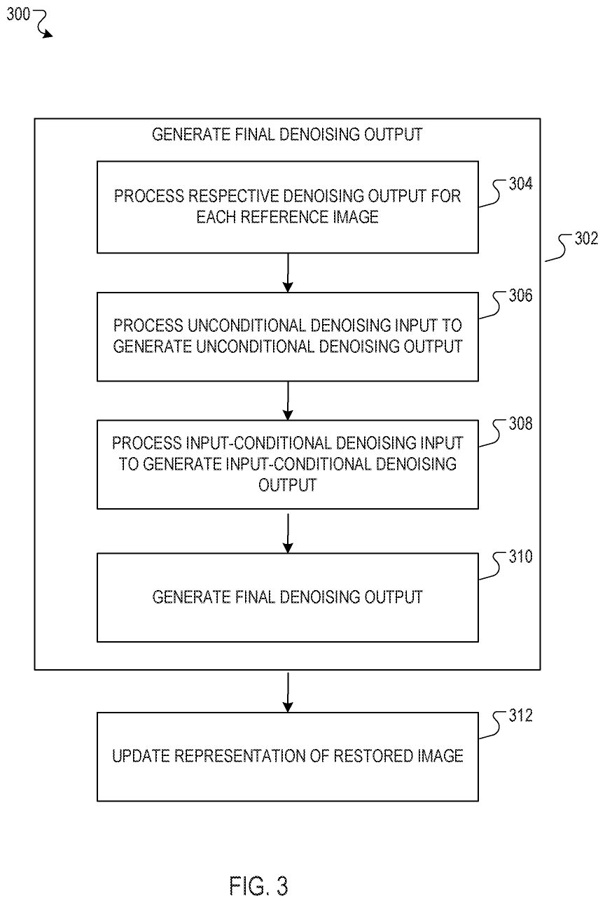

Updating the representation at a denoising step will be described in more detail below with reference to FIG. 3.

The denoising neural network 110 can have any appropriate architecture that allows the neural network to map a denoising input that includes an input representation of an image and to map the input representation to a denoising output that has the same dimensionality as the input representation.

For example, the denoising neural network 110 can be a convolutional neural network, e.g., a U-Net or other architecture that maps one input of a given dimensionality to an output of the same dimensionality.

As another example, the denoising neural network 110 can be a Transformer neural network that processes the denoising input through a set of self-attention layers to generate the denoising output.

As yet another example, the denoising neural network 110 can include both convolutional layers and self-attention layers.

The denoising neural network can be conditioned on a conditioning input, e.g., the degraded image or the composite embedded representation, in any of a variety of ways.

As one example, the denoising neural network can use an encoder neural network to generate one or more embeddings that represent the degraded image (a “representation” of the degraded image) and the denoising neural network can include one or more cross-attention layers that each cross-attend into the representation of the degraded image, the composite embedded representation, or both.

As another example, the denoising neural network can include one or more other types of neural network layers that are conditioned on the representation of the degraded image, the composite embedded representation, or both. Examples of such layers include Feature-wise Linear Modulation (FILM) layers, layers with conditional gated activation functions, and so on.

As another example, as will be described in more detail below, the output(s) of the encoder(s) when encoding the degraded image can be combined, e.g., through a sum, concatenation, or an average, with features of the representation of the restored image, and the combined features can be processed by denoising neural network.

An embedding, as used in this specification, is an ordered collection of numerical values, e.g., a vector of floating point values or other types of values. A representation of an image (or an “encoded representation”) is a collection of one or more embeddings, e.g., in the latent space described above, that represent the image.

The denoising input at any given denoising step can also include data defining a noise level for the denoising step. Generally, each denoising step has a corresponding time step t and the noise level for the iteration depends on the time step. For example, the noise level can be a decreasing function of the time step t. Examples of such functions include a linear function, a cosine function, and a sigmoid function. In these cases, data identifying the noise level, the time step, or both can be embedded using an appropriate neural network, e.g., a multi-layer perceptron (MLP) and used to condition the denoising neural network as described above for the conditioning input.

After the representation has been updated at the denoising step(s), the system generates the restored image from the representation of the restored image. For example, as described above, the representation of the restored image can be a representation in a latent space. In this example, the system generates the restored image by processing the representation using the decoder neural network. As another example, as described above, the representation of the restored image can be a representation in the pixel space. In this example, the system uses the representation as the restored image.

FIG. 3 is a flow diagram of an example process 300 for performing a denoising step. For convenience, the process 300 will be described as being performed by a system of one or more computers located in one or more locations. For example, an image restoration system, e.g., the image restoration system 100 of FIG. 1, appropriately programmed in accordance with this specification, can perform the process 300.

In particular, the process 300 describes an example of how the system updates the representation of the restored image at a given denoising step.

The system generates a final denoising output for the denoising step (step 302).

As part of this, the system processes, for each reference image, a respective denoising input for the denoising step that includes (i) the representation of the restored image, (ii) the representation of the input image, and (iii) the composite embedded representation of the reference image using the denoising neural network to generate a respective denoising output (step 304).

In some cases, the system generates the final denoising output from the respective denoising outputs for the one or more reference images. For example, when there is only a single reference image, the system can set, as the final denoising output, the respective denoising output for the reference image. When there are multiple reference images, the system can combine, e.g., average, the respective denoising outputs for the reference images to generate the final denoising output.

In some other cases, the system makes use of classifier-free guidance to improve the quality of the final denoising output.

For example, when using classifier-free guidance, the system can process an unconditional denoising input for the denoising step that includes the representation of the restored image (but that does not include the representation of the input image or any composite embedded representations) using the denoising neural network to generate an unconditional denoising output (step 306). The system can then generate the final denoising output using at least the denoising outputs for the one or more reference images and the unconditional denoising output.

As another example, the system can also process an input-conditional denoising input for the denoising step that include the representation of the restored image and the representation of the input image (but that does not include any composite embedded representations) using the denoising neural network to generate an input-conditional denoising output (step 308).

The system can then generate the final denoising output using at least the denoising outputs for the one or more reference images, the input-conditional denoising output and the unconditional denoising output (step 310).

In particular, the system can generate the final denoising output by combining the denoising outputs for the one or more reference images, the input-conditional denoising output and the unconditional denoising output in accordance with a set of classifier-free guidance weights for the denoising step.

As one example, when there are multiple reference images, the system can average the denoising outputs for the one or more reference images and then combine the averaged denoising outputs for the one or more reference images, the input-conditional denoising output and the unconditional denoising output in accordance with a set of classifier-free guidance weights for the denoising step. By averaging the denoising outputs before applying the classifier-free guidance weights, the system can effectively make use of a variable number of reference images when generating different restored images. In particular, the system can effectively use multiple reference images at inference time even if the denoising neural network was only trained on training examples that each included only a single reference image. This is advantageous because training examples that include multiple reference images of the same agent can be different to obtain or generate at scale.

As a particular example, when there is a single reference image, the system can generate the final denoising output at a denoising step t as follows:

\tilde{ϵ}(zₜ,z_{LQ},c,t)=(1−sᵢ)Σ(zₜ,Ø,Ø,t)+(sᵢ−s_{c})Σ(zₜ,z_{LQ},Ø,t)+s_{c}ϵ(zₜ,z_{LQ},c,t)

where ϵ represents the denoising neural network, zₜ is the representation of the restored image as of the denoising step t, z_{LQ} is the representation of the degraded image, sᵢ and s_{c} are respective classifier free guidance weights, Ø represents that the corresponding conditioning input is not included, and c is the composite embedded representation of the reference image.

When there are multiple reference images, the system can generate the final denoising output as follows:

$${ϵ}^{\text{?}} ( {z}_{t} , {z}_{LQ} , C , t ) = ( 1 - {s}_{i} ) ϵ ( {z}_{t} , ∅ , ∅ , t ) + ( {s}_{i} - {s}_{c} ) ϵ ( {z}_{t} , {z}_{LQ} , ∅ , t ) + \frac{{s}_{c}}{N} {\sum }_{i = 1}^{N} ϵ ( {z}_{t} , {z}_{LQ} , {c}_{i} , t )$$

$$\text{?} \text{indicates text missing or illegible when filed}$$

where N is the number of reference images and cᵢ is the composite embedded representation of the i-th reference image.

The system then updates the representation of the restored image using the final denoising output (step 312). For example, when the system is configured to perform a reverse diffusion process, the system can apply a diffusion sampler to the final denoising output to update the representation. As another example, when the system is configured to perform a flow matching process, the system can apply a flow matching update rule to the final denoising output to update the representation.

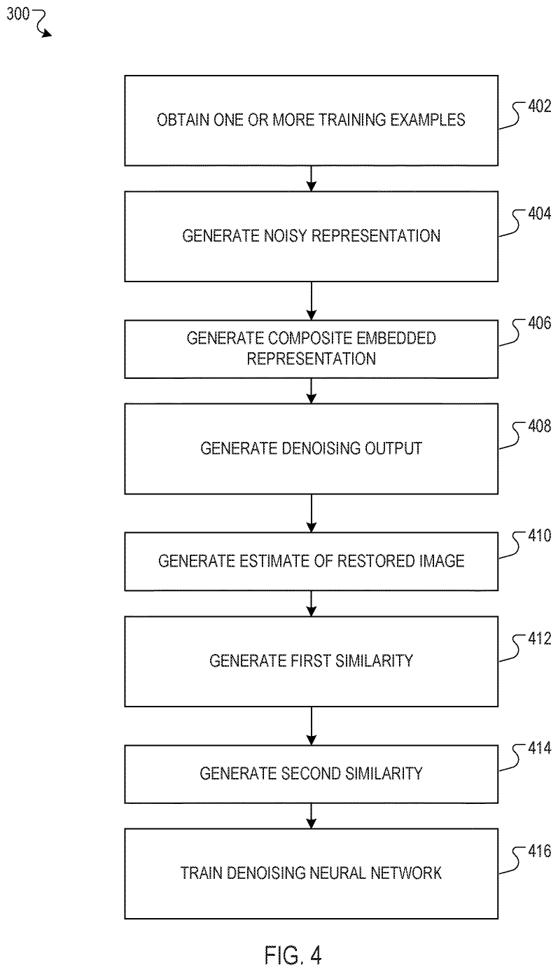

FIG. 4 is a flow diagram of an example process 400 for training the denoising neural network. For convenience, the process 400 will be described as being performed by a system of one or more computers located in one or more locations. For example, an image restoration system, e.g., the image restoration system 100 of FIG. 1, appropriately programmed in accordance with this specification, can perform the process 400.

The system can repeatedly perform iterations of the process 400 on different training examples to train the denoising neural network to accurately restore degraded face images. In some cases, the system performs the process 400 to train the denoising neural network from scratch, i.e., from randomly initialized parameter values. In some other cases, the system performs the process 400 to fine-tune an already pre-trained denoising neural network. For example, the denoising neural network can have previously been trained on a text-to-image generation objective on a large data set of images and corresponding text captions or on another appropriate objective that trains the denoising neural network to have high-quality general-purpose image generation capabilities.

The system obtains a set of one or more training examples (402). Each training example generally includes (i) a degraded image that depicts a face of an agent, (ii) a restored image that depicts the face of the agent, and (iii) a reference image that depicts the face of the agent.

The system then performs steps 404-414 for each training example.

The system generates a noisy representation of the restored image (404). For example, the system can sample noise from the noise distribution and an index for a denoising step and then combine the sampled noise and a representation of the restored image in accordance with a noise level associated with the sampled denoising step index to generate the noisy representation.

The system generates a composite embedded representation of the reference image (step 406) using the multiple embedding neural networks, e.g., as described above. The embedding neural networks are generally pre-trained and held fixed during the training of the denoising neural network.

The system processes a denoising input that includes (i) the noisy representation of the restored image, (ii) a representation of the degraded image, and (iii) the composite embedded representation of the reference image using the denoising neural network to generate a denoising output (step 408). While the description of FIG. 4 describes an example where the denoising neural network is conditioned on the composite embedded representation as described above, more generally, the described training techniques are applicable to any appropriate embedded representation of the reference image. For example, the described techniques can be used to train a denoising neural network that is conditioned on an embedded representation that is generated by a single embedding neural network.

The system generates an estimate of the restored image from the denoising output (step 410). In particular, the system can combine the noisy representation of the restored image and the denoising output to generate the estimate of the restored image. For example, when the system makes use of a reverse diffusion framework, the estimate can be determined as follows:

(xₜ−\sqrt{1−α̅ₜ}ϵ_{θ}(xₜ))/\sqrt{α̅t},

where t is the index for the sampled denoising step, xₜ is the noisy representation, ϵ_{θ} represents the denoising neural network, and αₜ is a noise level associated with t.

The system generates a first similarity between the restored image and the estimate of the restored image (step 412). For example, the system can process the restored image and the estimate using an embedding neural network, e.g., the ArcFace model described above, to generate a respective embedding for the restored image and the estimate. The system can then determine, e.g., a dot product or a cosine similarity, between the two embeddings.

The system generates a second similarity between the reference image and the estimate of the restored image (step 414). For example, the system can process the reference image using the embedding neural network, e.g., the ArcFace model described above, to generate a respective embedding for the reference image. The system can then determine, e.g., a dot product or a cosine similarity, between the embeddings of the reference image and the estimate of the restored image.

The system then trains the denoising neural network on an objective that measures, for each training example, (i) an error between the denoising output and a target denoising output for the restored image, (ii) the first similarity, and (iii) the second similarity (step 416).

The target denoising output can be the target output for the denoising framework used by the system, e.g., a diffusion target or a flow matching target. The error can be, e.g., a mean-squared error between the denoising output and the target denoising output or the L2 norm of the difference between the denoising output and the target denoising output.

To account for the first similarity, the objective can include a time-step scaled similarity loss:

[symbol]

_{ID}(x_{HQ},\hat{x})=\sqrt{α̅ₜ}·(1−cos(φH(x_{HQ}),φ_{H}(\hat{x})))

where t is the index for the sampled denoising step, x_{HQ} is the ground truth restored image, \hat{x} is the estimate of the restored image, φ_{H} is the embedding neural network, and αₜ is a noise level associated with t.

The time-step scaling factor α mitigates the out-of-domain behavior of the similarity loss at a very noisy step t, and emphasizes identity preservation at less noisy steps.

The objective can also include a time-step scaled similarity loss accounting for the second similarity, so that the overall loss term that depends on the similarities can be expressed as:

[symbol]

_{HID}(x_{HQ},x_{REF},\hat{x})=(1−λ) [symbol] _{ID}(x_{HQ},\hat{x})+λ [symbol] _{ID}(x_{REF},\hat{x})

where x_{REF} is the reference image.

When this loss is computed using only the first similarity score, the loss can decrease quickly and plateaus at a very small magnitude, leading to a learning inefficiency issue and degrading inference-time performance. By incorporating the similarity with the reference image into the loss, the loss will no longer plateau at a very small value because a “harder” example is introduced, i.e., the reference image, and hence will alleviate the learning inefficiency issue.

The overall objective can be a sum or a weighted sum between the error between the denoising output and target denoising output and the above loss.

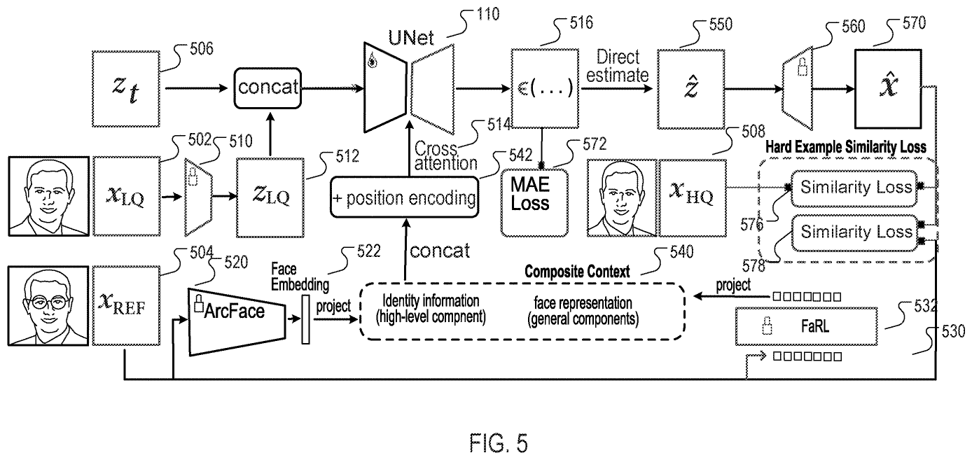

FIG. 5 shows an example 500 of the operation of the system during training. In particular, in the example 500, the denoising neural network 110 has a UNet architecture that includes one or more cross-attention layers 514.

As shown in the example 500, the system receives a “low-quality” image 502. The system processes the low-quality image 502 using an encoder neural network 510 to generate a representation 512 of the low-quality image in the latent space.

The system also receives a reference image 504 of the same agent as the low-quality image 502. The system processes the reference image 504 using a first embedding neural network 520 and a second embedding neural network 530. The first embedding neural network 520 generates a single embedding vector 522 and the second embedding neural network generates a set of embedding vectors 532. The system then projects the single embedding vector 522 and the set of embedding vectors 532 and then concatenates the resulting projected embeddings to generate a composite context 540. The system then adds position encodings 542 to the composite context 540 to generate the composite embedding representation of the reference image 504.

The system then uses the representation 512 and the composite embedding representation of the reference image 504 when performing a training step.

In particular, in the example 500, the system has generated a noisy representation 506 zt of a ground truth high-quality image 508. The system concatenates the noisy representation 506 zt with the representation 512 and processes the concatenation through the denoising neural network 110 to generate a denoising output 516. During the processing, the cross-attention layers 514 cross-attend into the composite embedding representation of the reference image 504, thereby conditioning the denoising output 516 on the reference image 504 as well as the low-quality image 502.

The system then generates, from the denoising output 516, an estimate 550 of the ground truth latent representation of the ground truth high-quality image 508 and processes the estimate 550 using a decoder neural network 560 to generate an estimate 570 of the ground truth high-quality image 508.

As shown in the example 500, the objective used for training the denoising neural network includes a mean-squared error (MSE) loss 572 between the denoising output 516 and a target denoising output for the ground truth high-quality image 508.

The objective also includes a first similarity loss 574 that is computed based on a similarity between the ground truth high-quality image and the estimate 570 of the ground truth high-quality image 508.

Additionally, the objective includes a second similarity loss 576 that is computed based on a similarity between the reference image 504 and the estimate 570 of the ground truth high-quality image 508.

Thus, the overall objective includes two separate similarity losses 574 and 576. Including the second similarity loss 576 can, as described above, mitigate training inefficiencies and improve the overall quality of the restored images that are generated after training.

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers, the method comprising:
receiving an input image that depicts a face of an agent;
receiving a set of one or more reference images that each depict the face of the agent;
for each reference image in the set of one or more reference images:
processing the reference image using each of a plurality of different embedding neural networks, wherein each of the plurality of embedding neural networks generates a respective set of one or more embeddings of the reference image; and
generating a composite embedded representation of the reference image from the respective sets of one or more embeddings generated by the plurality of different embedding neural networks; and
processing a representation of the input image and the respective composite embedded representations of each of the one or more reference images in the set of one or more reference images using a denoising neural network to generate a restored image that restores the input image.

2. The method of claim 1, wherein generating a composite embedded representation of the reference image from the respective sets of one or more embeddings generated by the plurality of different embedding neural networks comprises:
projecting each embedding in the respective sets of one or more embeddings to a shared projection space to generate a set of projected embeddings; and
concatenating the projected embeddings.

3. The method of claim 2, wherein generating a composite embedded representation of the reference image from the respective sets of one or more embeddings generated by the plurality of different embedding neural networks further comprises:
applying a positional encoding to the concatenated projected embeddings.

4. The method of claim 1, wherein each of the plurality of embedding neural networks has been trained to generate embeddings that represent different characteristics of the face of the agent from each other embedding neural network.

5. The method of claim 4, wherein the plurality of embedding neural networks comprises a first embedding neural network that has been trained to generate an embedding that represents an identity of the face of the agent.

6. The method of claim 4, wherein the plurality of embedding neural networks comprises a second embedding neural network that has been trained to generate an embedding that represents high-level semantic and low-level information of the face of the agent.

7. The method of claim 1, wherein processing a representation of the input image and the respective composite embedded representations of each of the one or more reference images in the set of one or more reference images using a denoising neural network to generate a restored image that restores the input image comprises:
initializing a representation of a restored image;
updating the representation of the restored image to generate a final representation of the restored image, the updating comprising, at each of a plurality of denoising steps:
generating a final denoising output for the denoising step, comprising processing, for each reference image, a respective denoising input for the denoising step that comprises (i) the representation of the restored image, (ii) a representation of the input image, and (iii) the composite embedded representation of the reference image using the denoising neural network to generate a respective denoising output; and
updating the representation of the restored image using the final denoising output; and
generating the restored image from the final representation of the restored image.

8. The method of claim 7, wherein the representation of the restored image and the representation of the input image are respective latent representations in a latent space.

9. The method of claim 8, further comprising:
generating the representation of the input image by processing the input image using an image encoder neural network.

10. The method of claim 8, wherein generating a restored image from the final representation of the restored image comprises:
processing the final representation of the restored image using an image decoder neural network to generate the restored image.

11. The method of claim 7, wherein generating a final denoising output for the denoising step further comprises:
processing an unconditional denoising input for the denoising step that comprises the representation of the restored image using the denoising neural network to generate an unconditional denoising output; and
generating the final denoising output using at least the denoising outputs for the one or more reference images and the unconditional denoising output.

12. The method of claim 11, wherein generating a final denoising output for the denoising step further comprises:
processing an input-conditional denoising input for the denoising step that comprises the representation of the restored image and the representation of the input image using the denoising neural network to generate an input-conditional denoising output; and
generating the final denoising output using at least the denoising outputs for the one or more reference images, the input-conditional denoising output and the unconditional denoising output.

13. The method of claim 12, wherein generating the final denoising output using at least the denoising outputs for the one or more reference images, the input-conditional denoising output and the unconditional denoising output comprises:
generating the final denoising output by combining the one or more reference images, the input-conditional denoising output and the unconditional denoising output in accordance with a set of classifier-free guidance weights for the denoising step.

14. A method performed by one or more computers, the method comprising:
obtaining one or more training examples, each training example comprising a degraded image that depicts a face of an agent, a restored image that depicts the face of the agent, and a reference image that depicts the face of the agent;
for each training example:
generating a noisy representation of the restored image;
generating an embedded representation of the reference image;
processing a denoising input that comprises (i) the noisy representation of the restored image, (ii) a representation of the degraded image, and (iii) the embedded representation of the reference image using the denoising neural network to generate a denoising output;
generating an estimate of the restored image from the denoising output;
generating a first similarity between the restored image and the estimate of the restored image; and
generating a second similarity between the reference image and the estimate of the restored image; and
training the denoising neural network on an objective that measures, for each training example, (i) an error between the denoising output and a target denoising output for the restored image, (ii) the first similarity, and (iii) the second similarity.

15. The method of claim 14, wherein the embedded representation of the reference image is a composite embedded representation, and wherein generating the composite embedded representation comprises:
processing the reference image using each of a plurality of different embedding neural networks, wherein each of the plurality of embedding neural networks generates a respective set of one or more embeddings of the reference image.

16. The method of claim 15, wherein generating the composite embedded representation further comprises:
projecting each embedding in the respective sets of one or more embeddings to a shared projection space to generate a set of projected embeddings; and
concatenating the projected embeddings.

17. The method of claim 16, wherein generating the composite embedded representation further comprises:
applying a positional encoding to the concatenated projected embeddings.

18. The method of claim 16, wherein each of the plurality of embedding neural networks has been trained to generate embeddings that represent different characteristics of the face of the agent from each other embedding neural network.

19. The method of claim 18, wherein the plurality of embedding neural networks comprises a first embedding neural network that has been trained to generate an embedding that represents an identity of the face of the agent.

20. A system comprising one or more computers and one or more storage devices storing instructions that when executed by the one or more computers cause the one or more computers to perform operations comprising:
receiving an input image that depicts a face of an agent;
receiving a set of one or more reference images that each depict the face of the agent;
for each reference image in the set of one or more reference images:
processing the reference image using each of a plurality of different embedding neural networks, wherein each of the plurality of embedding neural networks generates a respective set of one or more embeddings of the reference image; and
generating a composite embedded representation of the reference image from the respective sets of one or more embeddings generated by the plurality of different embedding neural networks; and
processing a representation of the input image and the respective composite embedded representations of each of the one or more reference images in the set of one or more reference images using a denoising neural network to generate a restored image that restores the input image.
